(19) United States
(12) Patent Application Publication
(10) Pub. No.: US 2025/0358693 A1
(43) Pub. Date: Nov. 20, 2025

(54) MULTI-HOP CONDITIONAL HANDOVER

(71) Applicant: INTERDIGITAL PATENT HOLDINGS, INC., Wilmington, DE (US)

(72) Inventors: Filipe Conceicao, London (GB); Oumer Teyeb, Montreal (CA); Yugeswar Deenoo Narayanan Thangaraj, Chalfont, PA (US); James Miller, Northport, NY (US)

(73) Assignee: INTERDIGITAL PATENT HOLDINGS, INC., Wilmington, DE (US)

(21) Appl. No.: 18/861,460

(22) PCT Filed: Apr. 28, 2023
(86) PCT No.: PCT/US2023/020464

§ 371 Date: Oct. 29, 2024

Related U.S. Application Data
(60) Provisional application No. 63/336,650, filed on Apr. 29, 2022.

(51) Int. Cl. H04W 36/00; H04W 36/36

(52) U.S. Cl. CPC H04W 36/00837; H04W 36/362

(57) ABSTRACT

A system and method for multi-hop conditional handovers are disclosed. In the system and method a WTRU may be configured plurality of conditional reconfigurations with an implicit or explicit relationship between the conditional reconfigurations. The WTRU behavior related to the handling of reconfigurations is based on the relationship between the configurations. The WTRU may be configured with a multi-hop CHO, where a CHO configuration to a first target cell is associated with another CHO configuration to a second target cell, which can also be further associated with yet another CHO configuration to a third target cell, and so on. On the fulfillment of a CHO configuration at the first hop, the WTRU executing the associated HO command, connecting to the first target, and staring to monitor the triggering conditions for the CHO configurations at the second hop that are associated with the first target.

### CROSS-REFERENCE TO RELATED APPLICATIONS

This application is the U.S. National Stage, under 35 U.S.C. § 371, of International Application No. PCT/US2023/020464 filed Apr. 28, 2023, which claims the benefit of U.S. Provisional Application No. 63/336,650 filed Apr. 29, 2022, the contents of which are incorporated herein by reference.

### BACKGROUND

The concept of conditional handover (CHO) is described with the main aim of reducing the likelihood of radio link failures (RLF) and handover failures (HOF). Legacy LTE/NR handover is typically triggered by measurement reports, even though there is nothing preventing the network from sending a HO command to the WTRU without receiving a measurement report. For example, the WTRU is configured with an A3 event that triggers a measurement report to be sent when the radio signal level/quality (RSRP, RSRQ, etc.) of a neighbor cell becomes better than the Primary serving cell (PCell). The WTRU monitors the serving and neighbor cells and sends a measurement report when the conditions get fulfilled. When such a report is received, the network (current serving node/cell) requests the best neighbor cell/node to admit the WTRU (sending a HO Request message), by including information about the WTRU context (e.g., configured bearers, WTRU capabilities, etc.).

If the neighbor cell/node has enough resources to accommodate the WTRU, the neighbor cell/node responds with a HO Request Acknowledge message. Embedded within this message is the actual HO command. The HO command is an RRC Reconfiguration message with the (possibly updated) WTRU bearer configuration and information required to access the target cell (e.g., the target cell ID, the new C-RNTI, the target gNB security algorithm identifiers for the selected security algorithms, dedicated RACH resources for performing initial random access, etc.). The serving cell/node transparently forwards this HO command to the WTRU. The WTRU executes the HO command resulting in the WTRU connecting to the target cell.

### SUMMARY

A system and method for multi-hop conditional handovers are disclosed. In the system and method a WTRU may be configured plurality of conditional reconfigurations with an implicit or explicit relationship between the conditional reconfigurations. The WTRU behavior related to the handling of reconfigurations is based on the relationship between the configurations. The WTRU may be configured with a multi-hop CHO, where a CHO configuration to a first target cell is associated with another CHO configuration to a second target cell, which can also be further associated with yet another CHO configuration to a third target cell, and so on. On the fulfillment of a CHO configuration at the first hop, the WTRU executing the associated HO command, connecting to the first target, and staring to monitor the triggering conditions for the CHO configurations at the second hop that are associated with the first target.

In the system and method a WTRU may be configured with a multi-hop CHO configuration of several hops. The WTRU may monitor the triggering conditions for the target at multiple levels at the same time, and if the triggering conditions at a deeper level than the current level are fulfilled, executing the HO commands at the previous levels (or at least the security updates needed for each HO) in sequence before executing the CHO at the deeper level. A WTRU may be configured with multi-hop CHO configurations that are constrained by validity times and monitoring the triggering conditions only for the specified validity time. A WTRU may be configured with multi-hop CHO configurations that are constrained by a start and stop times, and the WTRU starting to monitor the triggering conditions for that CHO configurations at the specified start time and stopping the monitoring at the stop times, if the conditions were not fulfilled.

In the system and method a WTRU may include receiving one or more multi-hop conditional handover (CHO) configurations associated with multiple hops of a handover (HO) including at least one parameter of the one or more CHO configuration. The at least one parameter of the one or more CHO configuration may include one or more of a set of target cells associated with a source cell, per each hop, one or more measurement criteria for HO associated with each of the hops, and a validity time duration for the monitoring of the one or more criteria for each or a subset of source and target cells. In the system and method a WTRU may include determining at least one hop criteria from the received one or more multi-hop CHO configurations. The determining at least one hop criteria may be based on at least one of a multi-hop CHO configuration, a current hop, and a previous hop source cell-target cell pair. In the system and method a WTRU may include determining at least one candidate target cell from the received one or more multi-hop CHO configurations. The determining at least one target cell may be based on at least one of: a multi-hop CHO configuration, a previous hop source-target pair, a current cell, a previous cell. In the system and method a WTRU may include monitoring the determined at least one hop criteria for at least one candidate target cell. In the system and method a WTRU may include determining a candidate target cell meets the criteria for the one or more monitored hop criteria. The target cell meeting the criteria may include meeting a threshold on a measurement. The criteria is based on the multi-hop CHO configuration, the current hop and a previous hop. In the system and method a WTRU may include transmitting using resources associated with the determined candidate target cell meeting the criteria. In the system and method a WTRU may further include triggering the HO associated with the current hop to the determined candidate target cell meeting the criteria. In the system and method a WTRU, based on the target cell to which the WTRU performs HO, may further include determining and monitoring the next hop criteria, for one or more target cells, as per the multi-hop CHO configuration associated with the previous hops and HOs.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates a signal diagram for a conditional handover configuration and execution;

FIG. 3A illustrates a configuration for HO;

FIG. 3B illustrates a method associated with the configuration for HO of FIG. 3A;

FIG. 4 illustrates a graphic of the key hierarchy generation in 5GS including security key derivations in NR;

FIG. 5A illustrates a diagram illustrating a mobile WTRU moving within a certain exemplary coverage scenario of 5G NR cells;

FIG. 5B illustrates a method associated with the exemplary coverage scenario of FIG. 5A;

FIG. 6 illustrates a configuration to illustrate the scenario of whether the message was sent before a WTRU has executed the first level CHO;

FIG. 7 illustrates a configuration to illustrate the scenario that while a WTRU is monitoring for CHO trigger, WTRU may exchange one or more RRC messages (e.g., measurement reports, UL information transfer, etc.) to cell A using a first security context associated with cell A;

FIG. 8 illustrates a configuration to illustrate the scenario when the trigger for cell A to cell B CHO is met, a WTRU attempts CHO from cell A to cell B;

FIG. 9 illustrates an enhanced HO request procedure;

FIG. 10 illustrates a multi-hop CHO WTRU configuration and HO trigger procedure; and

FIG. 11 illustrates a method that may be implemented by a wireless transmit receive unit (WTRU).

### DETAILED DESCRIPTION

A system and method are disclosed. The system and method may be implemented by a wireless transmit receive unit (WTRU). The system may include a transceiver and a processor operably connected to the transceiver. The system and method include receiving a plurality of multi-hop conditional handover (CHO) configurations, each configuration being associated with a hop criterion for a handover (HO), determining at least a first candidate target cell from the received plurality of multi-hop CHO configurations, monitoring at least a first hop criterion for the first candidate target cell, the first hop criterion associated with at least a first of the plurality of multi-hop CHO configurations, determining the first candidate target cell meets the first hop criterion using measurements associated with the first candidate target cell, establishing a connection to the determined first candidate target cell, determining at least a second candidate target cell from the received plurality of multi-hop CHO configurations, monitoring at least a second hop criterion for the second candidate target cell, the second hop criterion associated with at least a second of the plurality of multi-hop CHO configurations, determining the second candidate target cell meets the second hop criterion using measurements associated with the second candidate target cell, and establishing a connection to the determined second candidate target cell.

The system and method may include the monitoring at least a first hop criterion comprises the WTRU performing measurements and comparing the taken measurements to the first hop criterion. The system and method may include the first hop criterion and the second hop criterion being the same. The system and method may include of the processor and transceiver further operating to transmit using radio resources associated with the determined first candidate target cell based on the established connection with the determined first candidate target cell. The system and method may include the processor and transceiver further operating to transmit using radio resources associated with the determined second candidate target cell based on the established connection with the determined second candidate target cell. The system and method may include the processor and transceiver further operating to monitor at least a third hop criterion for a third candidate target cell, the third hop criterion associated with at least one of the plurality of multi-hop CHO configurations, determine the third candidate target cell meets the third hop criterion using measurements associated with the third candidate target cell and establishing a connection to the determined third candidate target cell. The system and method may include the received plurality of multi-hop CHO configurations comprises one or more of the following: a set of target cells associated with a source cell, per each hop; one or more measurement criteria for HO associated with each of the hops; and a validity time duration for the monitoring of the one or more criteria for each or a subset of source and target cells. The system and method may include the second hop criterion is based on at least one of: the received plurality of multi-hop CHO configurations; the established connection to the determined first candidate target cell; and a previous established connection of the WTRU and a previous hop criterion for a HO. The system and method may include determining at least the first target cell is based on at least one of: the received plurality of multi-hop CHO configurations, the established connection to the determined first candidate target cell, and a previous established connection of the WTRU and a previous hop criterion for a HO. The system and method may include the first candidate target cell meeting at least the first hop criterion includes exceeding a threshold on measurements associated with the first target cell.

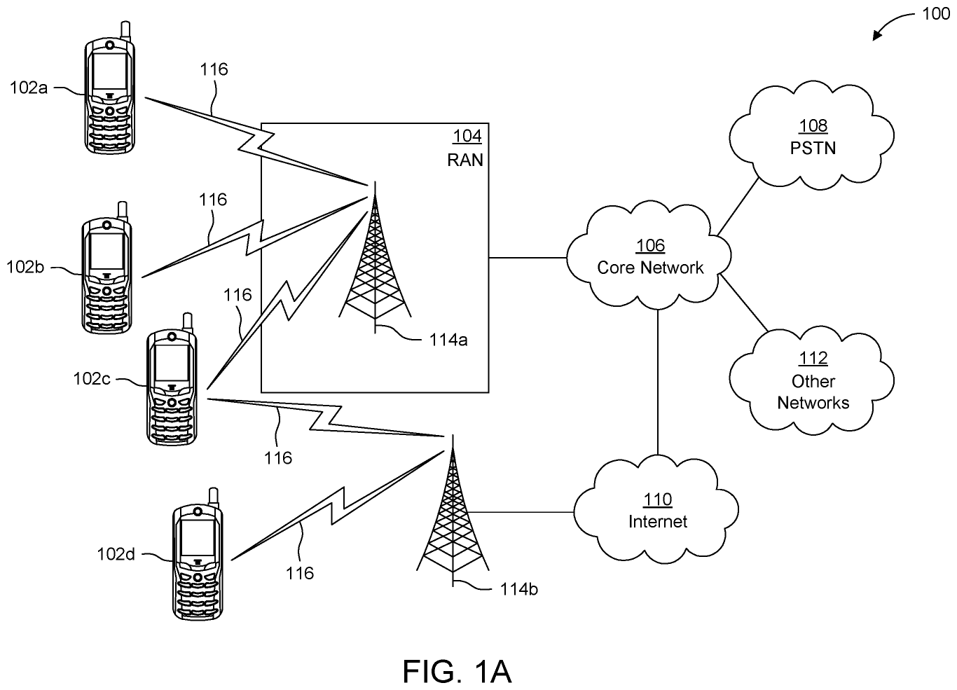

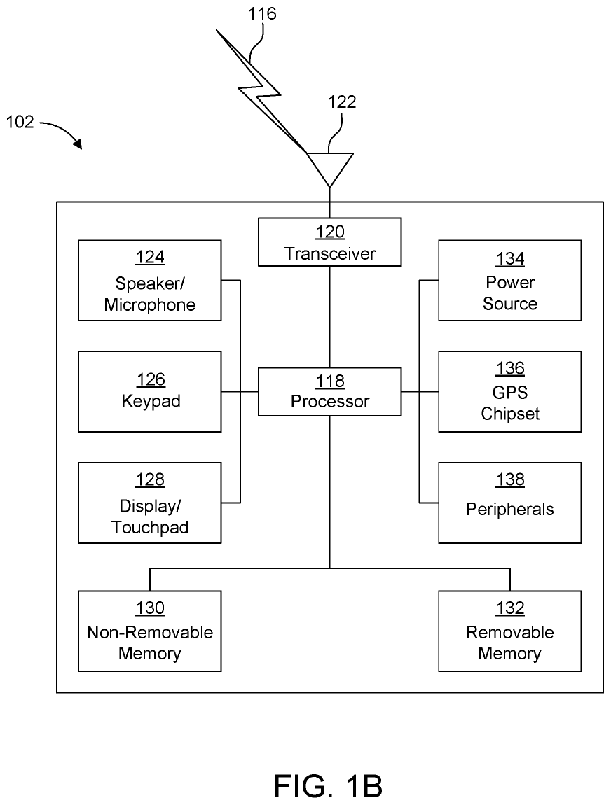

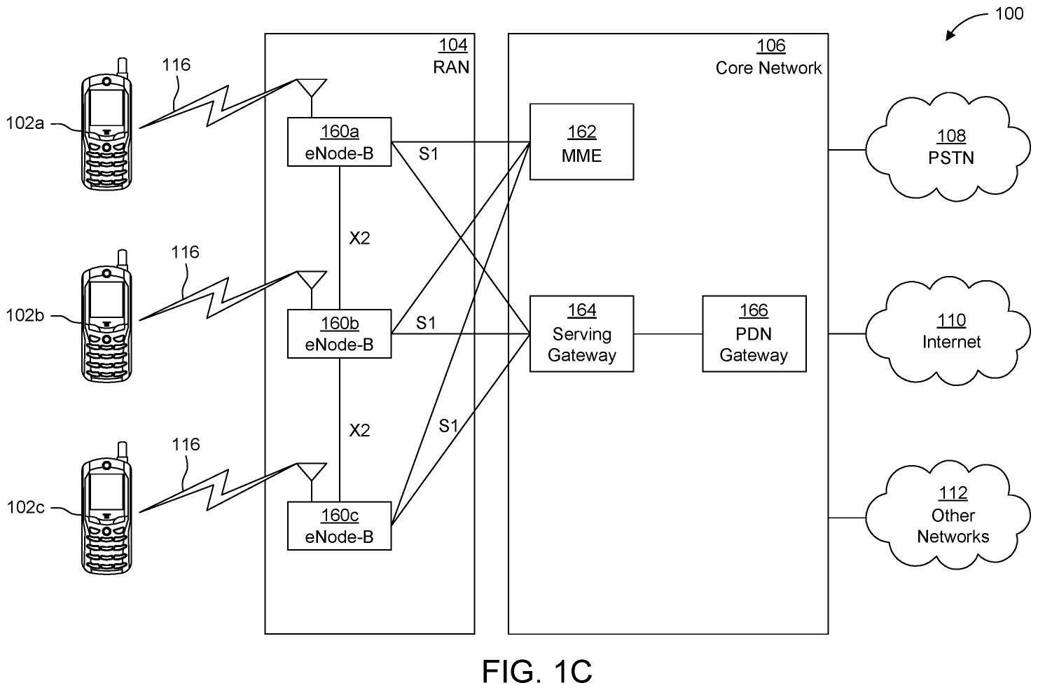

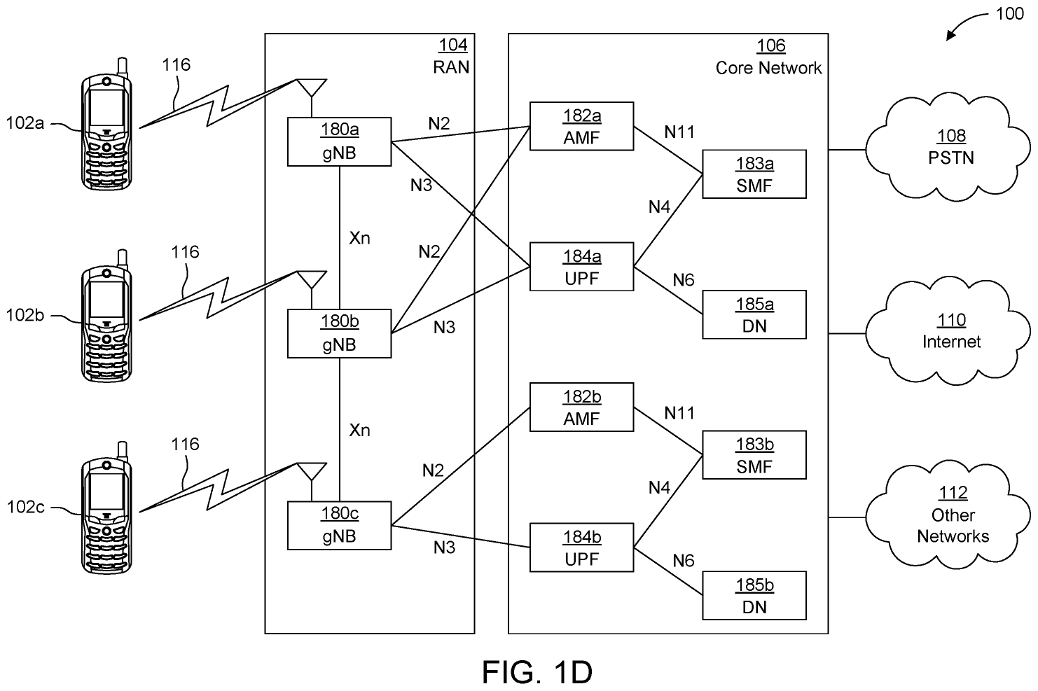

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) PacketAccess (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11 ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11 ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The concept of conditional handover (CHO) is described with the main aim of reducing the likelihood of radio link failures (RLF) and handover failures (HOF). Legacy LTE/NR handover is typically triggered by measurement reports, even though there is nothing preventing the network from sending a HO command to the WTRU without receiving a measurement report. For example, the WTRU is configured with an A3 event that triggers a measurement report to be sent when the radio signal level/quality (RSRP, RSRQ, etc.) of a neighbor cell becomes better than the Primary serving cell (PCell). The WTRU monitors the serving and neighbor cells and sends a measurement report when the conditions get fulfilled. When such a report is received, the network (current serving node/cell) requests the best neighbor cell/node to admit the WTRU (sending a HO Request message), by including information about the WTRU context (e.g., configured bearers, WTRU capabilities, etc.).

If the neighbor cell/node has enough resources to accommodate the WTRU, the neighbor cell/node responds with a HO Request Acknowledge message. Embedded within this message is the actual HO command. The HO command is an RRC Reconfiguration message with the (possibly updated) WTRU bearer configuration and information required to access the target cell (e.g., the target cell ID, the new C-RNTI, the target gNB security algorithm identifiers for the selected security algorithms, dedicated RACH resources for performing initial random access, etc.). The serving cell/node transparently forwards this HO command to the WTRU. The WTRU executes the HO command resulting in the WTRU connecting to the target cell.

CHO differs from legacy handover in two main aspects: multiple handover targets are prepared (as compared to only one target in legacy case); and the WTRU does not immediately execute the CHO as in the case of the legacy handover. Instead, the WTRU is configured with triggering conditions (a set of radio conditions), and the WTRU executes the handover towards one of the targets when/if the triggering conditions are fulfilled.

The CHO command may be sent when the radio conditions with respect to the current serving cells are still favorable, thereby reducing the two main points of failure in legacy handover/The two main points of failure include the WTRU being unable to send the measurement report on time, e.g., if the link quality to the current serving cell falls below acceptable levels when the measurement reports are triggered, and the failure to receive the handover command, e.g., if the link quality to the current serving cell falls below acceptable levels after the WTRU has sent the measurement report but before it has received the HO command.

The triggering conditions for a CHO may be based on the radio quality of the serving cells and neighbor cells just like the conditions that are used in legacy NR/LTE to trigger measurement reports. For example, the WTRU may be configured with a CHO that has an A3 like triggering condition(s) and associated HO command. The WTRU may monitor the current and serving cells and when the conditional A3 triggering condition(s) are fulfilled, the WTRU may, instead of sending a measurement report, execute the associated HO command to switch the connection to the target cell.

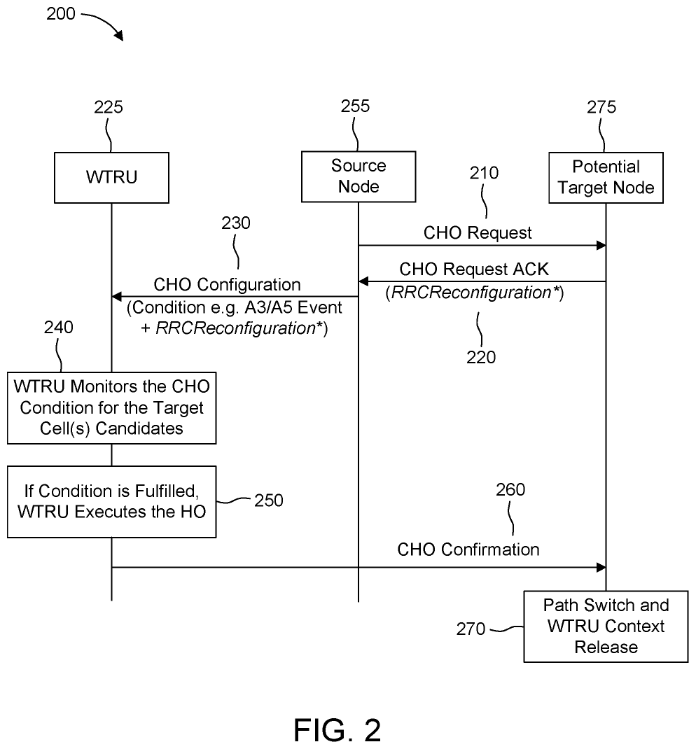

FIG. 2 illustrates a signal diagram 200 for a conditional handover configuration and execution. In FIG. 2, for the sake of brevity, only one target node 275 is configured for CHO. A WTRU 225 while operating with a source node 255 may be configured with an other potential target node 275. The source node 255 may initiate a CHO request with potential target node 275 at 210. At 220, potential target node 275 may acknowledge the CHO request to source note 255. Source node 255 may provide the CHO configuration to WTRU 225 at 230. At 240, WTRU 225 monitors the CHO condition for the target cell candidate(s). If a CHO condition is fulfilled, WTRU 225 may execute the HO at 250. WTRU 225 may send a CHO confirmation to the potential target node 275 (that is in the process of being handed over to) at 260. Potential target node 275 operates to switch the path and provides WTRU 225 context release at 270.

As would be understood, the network may prepare several CHO candidates and provide the WTRU 225 with a multitude of CHO configuration(s), each corresponding with a particular CHO candidate. WTRU 225 may monitor the triggering conditions for the different CHO configuration(s), and may execute the CHO towards the target that fulfills the triggering conditions, such as the first target to fulfill, for example. Upon the execution of a CHO, WTRU 225 may delete/release the other CHO configurations. The network may release the resources that were reserved for WTRU 225 at the candidate CHO targets except the one where WTRU 225 is handed over to.

Another benefit of CHO is the elimination of unnecessary re-establishments in case of a radio link failure. For example, if WTRU 225 is configured with multiple CHO targets and WTRU 225 experiences an RLF before the triggering conditions with any of the targets gets fulfilled, legacy operation would have resulted in an RRC re-establishment procedure that would have incurred considerable interruption time for the bearers of the WTRU. However, in the case of CHO, if WTRU 225, after detecting an RLF, ends up with a cell for which WTRU 225 has a CHO associated with (i.e., the target cell is already prepared for the WTRU), WTRU 225 executes the HO command associated with this target cell, instead of continuing with the full re-establishment procedure.

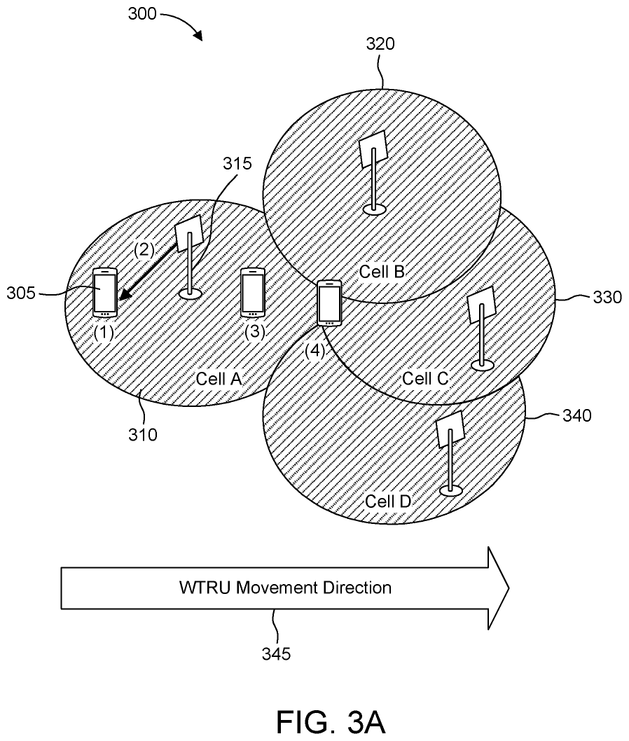

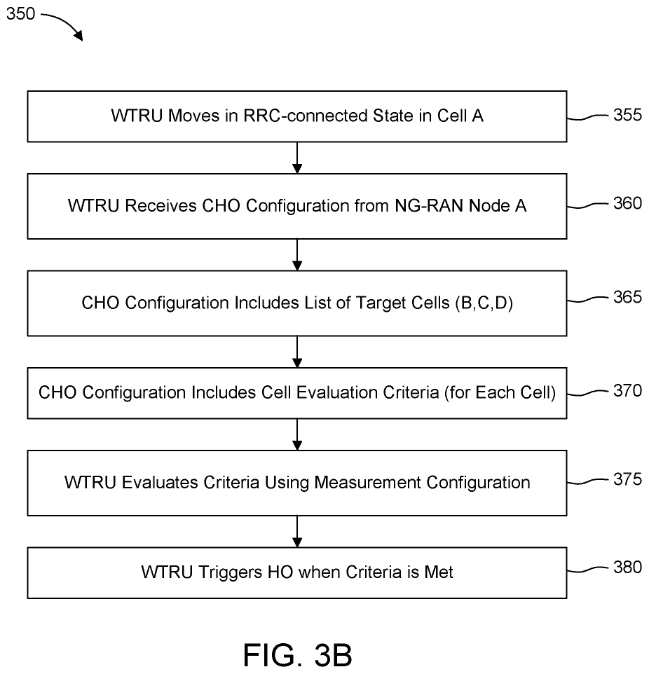

FIG. 3A illustrates a configuration for HO 300. FIG. 3B illustrates a method 350 associated with the configuration for HO 300 of FIG. 3A. In FIGS. 3A, B, a WTRU 305 moves in RRC_CONNECTED state in cell A 310 at 355. At 360, WTRU 305 receives CHO configuration from NG-RAN node A 315. This may include a list of target cells (B, C, D) at 365 and a cell evaluation criteria at 370, that in one embodiment may be per cell. WTRU 305 may evaluate the criteria according to the measurement configuration at 375. WTRU 305 may trigger HO when the criteria is met at 380. For example, as WTRU 305 moves at 345, cell B 320, cell C 330 and cell D 340 may be monitored. As this movement leads WTRU 305 to measure that the criteria of one cell (cell B 320, cell C 330 and cell D 340) is met, the HO to that cell may be triggered.

The CHO configuration may be configured with the WTRU configuration. In NR, each measurement configuration is identified by a unique measID and is associated with a measObject and a reportConfig. The following Tables 1-3 illustrates the information elements (IEs) (included within an RRC Reconfiguration message) that are used to configure the WTRU with measurement and measurement reporting.

TABLE 1
MeasIdToAddModList information element

-- ASN1START
-- TAG-MEASIDTOADDMODLIST-START

| | |
|---|---|
| MeasIdToAddModList ::= | SEQUENCE (SIZE (1..maxNrofMeasId)) |
| | OF MeasIdToAddMod |
| MeasIdToAddMod ::= | SEQUENCE { |
| measId | MeasId, |
| measObjectId | MeasObjectId, |
| reportConfigId | ReportConfigId |

}
-- TAG-MEASIDTOADDMODLIST-STOP
-- ASN1STOP

TABLE 2
MeasObjectToAddModList information element

-- ASN1START
-- TAG-MEASOBJECTTOADDMODLIST-START

| | |
|---|---|
| MeasObjectToAddModList ::= | SEQUENCE (SIZE |

(1..maxNrofObjectId)) OF MeasObjectToAddMod

| | |
|---|---|
| MeasObjectToAddMod ::= | SEQUENCE { |
| measObjectId | MeasObjectId, |
| measObject | CHOICE { |
| measObjectNR | MeasObjectNR, |

...,

| | |
|---|---|
| measObjectEUTRA | MeasObjectEUTRA, |
| measObjectUTRA-FDD-r16 | MeasObjectUTRA-FDD-r16, |
| measObjectNR-SL-r16 | MeasObjectNR-SL-r16, |
| measObjectCLI-r16 | MeasObjectCLI-r16 |

}
}
-- TAG-MEASOBJECTTOADDMODLIST-STOP
-- ASN1STOP

TABLE 3
ReportConfigToAddModList information element

| -- ASN1START | |
|---|---|
| -- TAG-REPORTCONFIGTOADDMODLIST-START | |
| ReportConfigToAddModList ::= | SEQUENCE (SIZE |
| (1..maxReportConfigId)) OF ReportConfigToAddMod | |
| ReportConfigToAddMod ::= | SEQUENCE { |
| reportConfigId | ReportConfigId, |
| reportConfig | CHOICE { |
| reportConfigNR | ReportConfigNR, |
| ..., | |
| reportConfigInterRAT | ReportConfigInterRAT, |
| reportConfigNR-SL-r16 | ReportConfigNR-SL-r16 |

}
}
-- TAG-REPORTCONFIGTOADDMODLIST-STOP
-- ASN1STOP

A WTRU may be provided with a CHO configuration (or more accurately, Conditional Reconfiguration) using an RRC message that contains the IcondReconfigToAddModList, that is defined as follows:

| | |
|---|---|
| CondReconfigToAddMod-r16 ::= | SEQUENCE { |
| condReconfigId-r16 | CondReconfigId-r16, |
| condExecutionCond-r16 | SEQUENCE (SIZE (1..2)) OF |
| | MeasId |

OPTIONAL, -- Cond condReconfigAdd

| | |
|---|---|
| condRRCReconfig-r16 | OCTET STRING (CONTAINING |
| | RRCReconfiguration) |

OPTIONAL, -- Cond condReconfigAdd
...
}

where condExecutionCond-r16 is the execution condition that needs to be fulfilled in order to trigger the execution of a conditional reconfiguration, given by a MeasID, i.e., the binding of specific measurement object and reporting configuration that are linked to a particular cell ID.

The particular CHO triggering criteria may be defined by the reporting criteria when it is set for CHO instead of measurement reporting.

In an example, the IE ReportConfigNR can be seen below:

| | |
|---|---|
| ReportConfigNR ::= | SEQUENCE { |
| reportType | CHOICE { |
| periodical | PeriodicalReportConfig, |
| eventTriggered | EventTriggerConfig, |

...,

| | |
|---|---|
| reportCGI | ReportCGI, |
| reportSFTD | ReportSFTD-NR, |
| condTriggerConfig-r16 | CondTriggerConfig-r16, |
| cli-Periodical-r16 | CLI-PeriodicalReportConfig-r16, |
| cli-EventTriggered-r16 | CLI-EventTriggerConfig-r16 |

}
}

and where condExecutionCond-r16 is defined as

| | |
|---|---|
| CondTriggerConfig-r16 ::= | SEQUENCE { |
| condEventId | CHOICE { |
| condEventA3 | SEQUENCE { |
| a3-Offset | MeasTriggerQuantityOffset, |
| hysteresis | Hysteresis, |
| timeToTrigger | TimeToTrigger |

},

| | |
|---|---|
| condEventA5 | SEQUENCE { |
| a5-Threshold1 | MeasTriggerQuantity, |
| a5-Threshold2 | MeasTriggerQuantity, |
| hysteresis | Hysteresis, |
| timeToTrigger | TimeToTrigger |

```
    },
    ...
  },
```

| | |
|---|---|
| rsType-r16 | NR-RS-Type, |

...
}

In practical terms this means two events can be used as triggers for the WTRU triggering a CHO including CondEventA3: The conditional reconfiguration candidate may become the amount of the offset better than PCell/PSCell, and CondEventA5: The PCell/PSCell may become worse than absolute threshold1 and the conditional reconfiguration candidate may become better than another absolute threshold2. The criteria for the event may be met for a duration specified in the timeToTrigger parameter before the conditions for the criteria are considered to be fulfilled and the WTRU executes the conditional reconfiguration evaluation.

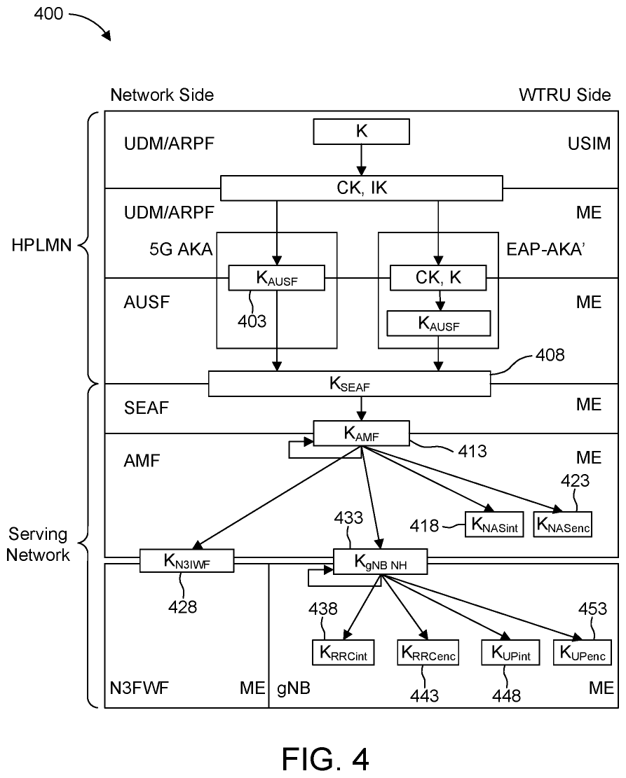

FIG. 4 illustrates a graphic 400 of the key hierarchy generation in 5GS including security key derivations in NR. The following describes the keys of the key hierarchy generation. The key hierarchy may include the following keys: K_{AUSF} 403, K_{SEAF} 408, K_{AMF} 413, K_{NASInt} 418, K_{NASenc} 423, K_{N3IWF} 428, K_{gNB} 433, K_{RRCint} 438, K_{RRCenc} 443, K_{UPint} 448 and K_{UPenc} 453. While many of these key hierarchies are understood the following discussion is related to the access stratum.

The key for NG-RAN includes K_{gNB} 433 derived by ME and AMF from K_{AMF} 413. K_{gNB} 433 is further derived by ME and source gNB when performing horizontal or vertical key derivation. The K_{gNB} 433 is used as K_{eNB} between ME and ng-eNB.

The keys for UP traffic include K_{UPenc} 453 derived by ME and gNB from K_{gNB} 433, which is used for the protection of UP traffic with a particular encryption algorithm and K_{UPnt} 448 derived by ME and gNB from K_{gNB} 433, which is used for the protection of UP traffic between ME and gNB with a particular integrity algorithm.

The keys for RRC signaling include K_{RRCint} 438 derived by ME and gNB from K_{gNB} 433, which is used for the protection of RRC signalling with a particular integrity algorithm and K_{RRCenc} 443 derived by ME and gNB from K_{gNB}, which is used for the protection of RRC signalling with a particular encryption algorithm.

The intermediate keys include NH derived by ME and AMF to provide forward security and K_{NG-RAN}* (K_{gNb}* if the target is a gNB or K_{eNB}* if the target is an eNB) derived by ME and NG-RAN (i.e., gNB or ng-eNB) when performing a horizontal or vertical key derivation.

Whenever an initial AS security context needs to be established between the WTRU and gNB, AMF and the WTRU derive a K_{gNB} 433 and a Next Hop parameter (NH). The K_{gNB} 433 and the NH are derived from the K_{AMF} 413. A NH Chaining Counter (NCC) and is associated with each K_{gNB} 433 and NH parameter. Every K_{gNB} 433 is associated with the NCC corresponding to the NH value from which it was derived. At initial setup, the K_{gNB} 433 is derived directly from K_{AMF} 413, and is then considered to be associated with a virtual NH parameter with NCC value equal to zero. At initial setup, the derived NH value is associated with the NCC value one. On handovers, the basis for the K_{gNB} 433 that will be used between the WTRU and the target gNB, called K_{gNB}*, is derived from either the currently active K_{gNB} 433 or from the NH parameter. If K_{gNB}* is derived from the currently active K_{gNB} 433, this is referred to as a horizontal key derivation and is indicated to WTRU with an NCC that does not increase. If the K_{gNB}* is derived from the NH parameter, the derivation is referred to as a vertical key derivation and is indicated to WTRU with an NCC increase. Finally, K_{RRCint} 438, K_{RRCenc} 443, K_{UPint} 448 and K_{UPenc} 453 are derived based on K_{gNB} 433 after a new K_{gNB} 433 is derived.

With such key derivation, a gNB with knowledge of a K_{gNB} 433, shared with a WTRU, is unable to compute any previous K_{gNB} 433 that has been used between the same WTRU and a previous gNB, therefore providing backward security. Similarly, a gNB with knowledge of a K_{gNB} 433, shared with a WTRU, is unable to predict any future K_{gNB} 433 that will be used between the same WTRU and another gNB after n or more handovers (since NH parameters are only computable by the WTRU and the AMF).

On handovers with vertical key derivation, the NH is further bound to the target PCI and its frequency ARFCN-DL before it is taken into use as the K_{gNB} 433 in the target gNB. On handovers with horizontal key derivation, the currently active K_{gNB} 433 is further bound to the target PCI and its frequency ARFCN-DL before it is taken into use as the K_{gNB} 433 in the target gNB. That is, when deriving the K_{gNB} 433, the PCI and the ARFCN (i.e., absolute frequency of SSB of the target cell), are used as input to the security key derivation function (KDF).

The WTRU is provided with baseline security key (e.g., K_{gNB} 433, NH) that it uses to derive the actual security keys for encryption and integrity protection in the UL, and decryption and integrity verification in the DL, both for the UP and CP. The derivation of these keys may use cell specific information such as PCI and frequency used in the cell.

When a WTRU is handed over, the security keys need to be updated (i.e., both the target and the WTRU may start using the updated keys), and this is one of the main functions of the handover procedure.

When the WTRU is configured with a CHO, it means that the CHO candidate cell has performed admission control and reserved the required resources to accommodate the WTRU. Because the WTRU is given a radio conditions related criteria that needs to be met before it executes the CHO, the NW nodes does not know exactly when the WTRU will execute the CHO. As a consequence, the target node needs to keep the concerned resources reserved until the WTRU is handed over (i.e., CHO conditions are met and WTRU executes the CHO command) or the source indicates to the target to release the resources (e.g., if there were multiple CHO targets, when the WTRU performs the CHO to one of the targets, that particular target node will inform the source node, and the source will communicate to the rest of the targets to cancel the CHO and release the resources reserved for that WTRU).

The more target cells are prepared, the higher likelihood that RLF/HOF are prevented, and the WTRU may connect to the best target cell. However, preparing a multitude of target cells is resource intensive and also the number of simultaneous CHO configuration/monitoring the WTRU can perform is limited to 8, in some embodiments (maxNrofCondCells). Thus, the network may make a compromise and limit the number of CHO targets (e.g., depending on the load conditions).

A handover, be it HO based on measurement reports or CHO, is a one hop system/decision that involves one source node/cell and target node/cell. As the source node can only be aware of its own neighbor cells and some knowledge of where the WTRU is headed (e.g., measurement reports or some WTRU location/trajectory information, if available), then the source node can provide the WTRU with a one hop HO/CHO configuration.

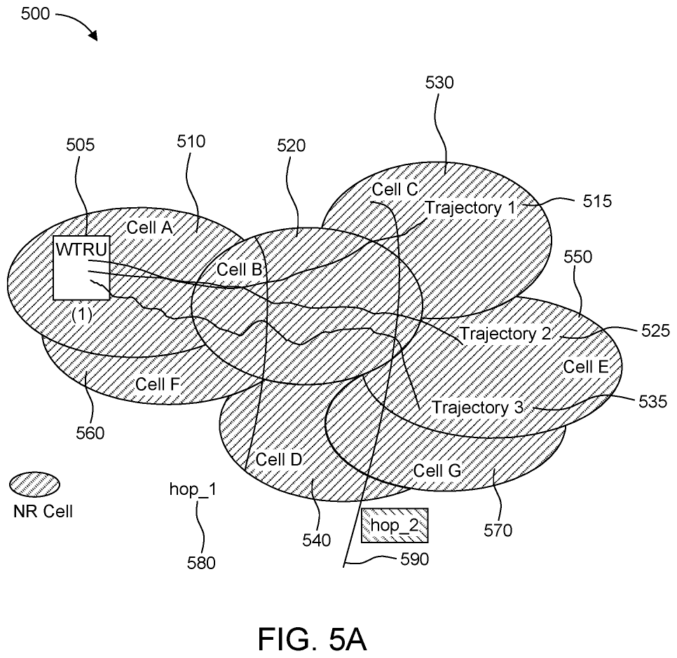

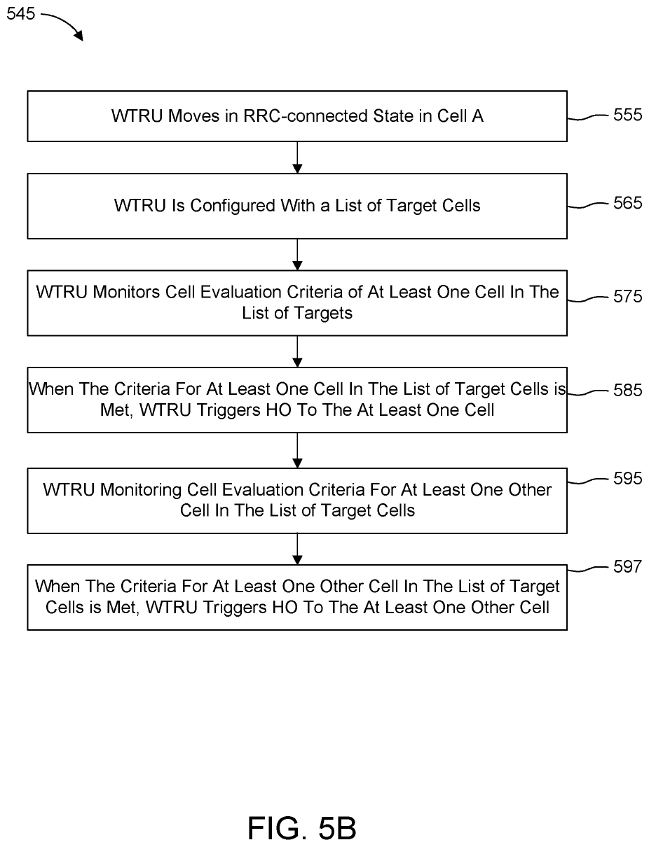

FIG. 5A illustrates a diagram 500 illustrating a mobile WTRU moving within a certain exemplary coverage scenario of 5G NR cells. For this discussion it is assumed that all cells belong to different base stations. Under the current 3GPP specifications, a WTRU 505 in cell A 510 may receive multiple CHO configurations for hop 1 (one concerning each neighbor cell of cell A 510, i.e., cell B 520, cell D 540 and cell F 560). If the CHO triggering conditions for cell B 520 get fulfilled and WTRU 505 hands over to cell B 520. WTRU 505 deletes the CHO configuration towards cell D 540 and cell F 560 upon the HO. If CHO is to be used (again) while in cell B 520, then WTRU 505 has to be provided with additional CHO configurations while in cell B 520, this time probably concerning cell A 510, cell C 530, cell D 540, cell E 550, cell F 560 and cell G 570. This procedure is repeated after each CHO execution (i.e., CHO to one candidate target executed, all other CHO configurations released, the new serving cell/node providing WTRU 505 with new CHO configurations associated with the neighbors of the new serving cell, and so on . . . ).

If the network is not aware of the trajectory of WTRU 505, this method may provide a reasonable/practical way to perform handovers. However, if the network can predict/estimate the trajectory of WTRU 505 (e.g., based on AI/ML techniques, possibly with some feedback information from WTRU 505), it is sub-optimal to limit the CHO configuration to only one hop, for example, for failure cases, signaling overhead and trajectory information not being used to the fullest.

For failure cases, the CHO towards a target may fail due to several reasons (e.g., RA failure due to RACH congestion). Re-establishment may be triggered when a failure occurs (unless the cell re-selection after the failure is to another CHO candidate cell, in which case the CHO to that target is executed).

However, a better solution, both from signaling and WTRU performance point of view may be to keep WTRU 505 in the source cell (e.g., if the conditions towards the source cell were still good enough) or immediately perform the CHO to a neighbor cell of the source cell or the target cell, as described herein.

For signaling overhead, when the WTRU hands over from a source cell to a target cell, there can be a multitude of cells that are mutual neighbors of both cells. Shortly after the HO, the WTRU 505 may need to switch cells again. Without the example, other configurations may be released. Additionally, or alternatively, the use of both cells may benefit when a failure occurs when a cell switch fails shortly after execution of the HO and the other configurations exist for the WTRU 505 to execute.

With current CHO mechanisms, WTRU 505 has to release the CHO configuration to these neighbor cells on CHO execution and has to receive CHO configurations regarding these neighbor cells from the target cell. In diagram 500 of FIG. 5A, WTRU 505 releases the CHO configurations towards cell D 540 and cell F 560 on handover to cell B 520, and is then again provided with CHO configurations towards cell D 540 and cell F 560. The new CHO configurations may involve unnecessary signaling and processing on the network side (e.g., cell A 510 informing cell D 540 and cell F 560 to reserved resources for WTRU 505 and then to release the resources, cell B 520 informing cell D 540 and cell F 560 to reserve the resources back again, etc.).

The network may have more accurate predictions of the WTRU's trajectory with the adoption of AI/ML techniques in the RAN. The network can make very accurate estimates when exactly and to which particular cell the WTRU needs to be handed over. With only one-hop handover, such trajectory information can only be used at once cell at a time, instead of a more optimal handover configuration that may be used by the WTRU for a longer duration as the WTRU traverses several cells. Current CHO mechanisms defined in 3GPP allow only one hop CHO that are sub optimal, both from WTRU/network signaling overhead and WTRU performance. The present system and method for enabling multi-hop CHOs are disclosed. To configure the multi-hop CHO, the network may employ information it may have regarding the predicted WTRU trajectory, current and predicted network resources at target nodes, etc. The details of how the network is able to gather this information would be understood by those possessing an ordinary skill in the art. In this description of the solutions below, the terms “level”, “depth” and “hop” are used interchangeably.

A WTRU may be configured with a plurality of conditional reconfigurations with an implicit or explicit relationship between the conditional reconfigurations (or parts thereof). The WTRU behavior related to the handling of reconfigurations (or parts thereof) may be based on the relationship between the configuration. In one solution, the WTRU may receive plurality of conditional reconfiguration and an explicit relationship between the conditional reconfigurations. For example, the explicit relationship may be configured by signaling a linkage between the identity associated with each conditional reconfiguration. The linkage may be sequential or parallel. In another solution, the WTRU may receive plurality of conditional reconfiguration and an implicit relationship between the conditional reconfigurations. For example, the implicit relationship may be configured by signaling sequential conditional reconfiguration as a list within an AddModList information element.

A WTRU may receive plurality of conditional reconfigurations with a sequential relationship between the conditional reconfigurations. In one solution, the WTRU may be configured with a first conditional reconfiguration, a second conditional reconfiguration and a sequential relationship between the first and second conditional reconfigurations. When a sequential relationship is configured, the WTRU may consider the second conditional reconfiguration to be valid only after a successful application of the first conditional reconfiguration.

A WTRU may receive plurality of conditional reconfigurations with a different relationship between the execution condition and RRC reconfigurations of individual conditional reconfigurations. A conditional reconfiguration may have two parts—a execution condition and RRC reconfiguration—wherein the WTRU may be configured to apply the RRC reconfiguration when the execution condition is satisfied. In a solution, a WTRU may receive a first conditional reconfiguration and a second conditional reconfiguration—wherein different relationships may be configured between the execution conditions and RRC reconfigurations contained within the first and second conditional reconfiguration. In one example, a WTRU may be configured with sequential relationship between execution condition in the first conditional reconfiguration and execution condition in the second conditional reconfiguration. In such an example, the WTRU may start to monitor for execution condition associated with second conditional reconfiguration upon successful application of RRC configuration associated with first conditional reconfiguration. In another example, the WTRU may be configured with parallel relationship between the execution condition in the first conditional reconfiguration and the execution condition in the second conditional reconfiguration. In such an example, the WTRU may start to monitor for the execution condition associated with second conditional reconfiguration at the same time it starts to monitor for the execution condition associated with first conditional reconfiguration.

One or more solutions described herein may be extended to N number of conditional reconfigurations. Each conditional reconfiguration may have a sequential relationship with one other conditional reconfiguration (or parts thereof)—leading to N−1 sequential relationships. This may be extended to a case where a first conditional reconfiguration may have a sequential relationship with N other conditional reconfigurations (or parts thereof). The N other conditional reconfiguration (or parts thereof) may become valid when the first conditional reconfiguration is successful.

From the WTRU perspective, there may be configured baseline multi-hop CHO configurations. The WTRU may be configured with a CHO configuration that is related to a sequential HO towards several cells, i.e., containing several levels/hops. The WTRU monitors the triggering conditions of the target cells at the same level/hop of the CHO configuration. When the conditions for one of the target cells is fulfilled, the WTRU may execute the CHO associated with this target cell, while keeping the CHO configurations that are in the next levels that are related to the selected candidate cell, and release the other CHO configurations.

One such example configuration is provided below with respect to FIG. 5A. Generally this type of configuration may be referred to as baseline multi-hop CHO configuration. The configuration may be provided to WTRU 505 when WTRU 505 is in source cell S (not shown):
1. CHO Config A:
   Target cell: cell A 510
   Triggering conditions (e.g., Cond A3 event with threshold_A)
   HO command_A
      2. CHO config B
         Target cell: cell B 520
         Triggering conditions (e.g., cond A3 event with threshold_B)
         HO command_B
         3. CHO config C
         Target cell: cell C 530
         Triggering conditions (e.g., cond A3 event with threshold_C)
         HO command_C
      2. CHO config D
         Target cell: cell D 540
         Triggering conditions (e.g., cond A3 event with threshold_D)
         HO command_D
         3. CHO config E
         Target cell: cell E 550
         Triggering conditions (e.g., cond A3 event with threshold_E_1)
         HO command_E
1. CHO Config F:
   Target cell: cell F 560
   Triggering conditions (e.g., Cond A3 event with threshold_F)
   HO command_F
      2. CHO config G
         Target cell: cell G 570
         Triggering conditions (e.g., cond A3 event with threshold_G)
         HO command_G

WTRU 505 may begin monitoring the radio conditions for cell A 510 and cell F 560 (i.e., the first hop target cells in the multi-hop CHO configuration). If the CHO towards cell A 510 is executed, then WTRU 505 may execute the CHO towards cell A 510 and may keep the second level CHO configurations related to cell A 510. That is, after the HO towards cell A 510, the CHO configuration at WTRU 505 becomes:
1. CHO config B
   Target cell: cell B 520
   Triggering conditions (e.g., cond A3 event with threshold_B)
   HO command_B
      2. CHO config C
         Target cell: cell C 530
         Triggering conditions (e.g., cond A3 event with threshold_C)
         HO command_C
1. CHO config D
   Target cell: cell D 540
   Triggering conditions (e.g., cond A3 event with threshold_D)
   HO command_D
      2. CHO config E
         Target cell: cell E 550
         Triggering conditions (e.g., cond A3 event with threshold_E_1)
         HO command_E
            WTRU 505 may begin monitoring the triggering conditions for the second hop target cell B 520 and cell D 540, and so on.

The baseline multi-hop CHO configuration can be introduced by including a reference from one conditional reconfiguration to another. One example is shown below:

| | |
|---|---|
| CondReconfigToAddMod-r18 ::= | SEQUENCE { |
| condReconfigId-r16 | CondReconfigId-r16, |
| condExecutionCond-r16 | SEQUENCE (SIZE (1..2)) OF |
| | MeasId |

OPTIONAL, -- Cond condReconfigAdd

| | |
|---|---|
| condRRCReconfig-r16 | OCTET STRING (CONTAINING |
| | RRCReconfiguration) |

OPTIONAL, -- Cond condReconfigAdd
...,

| | |
|---|---|
| parentCondReconfigId-r18 | CondReconfigId-r16 OPTIONAL |

}

For the baseline multi-hop CHO example above, the CHO configuration regarding cell B 520 may include the ID of the CHO configuration regarding cell A 510, and so on.

WTRU 505 may monitor triggering condition(s) for more than one hop at a time. WTRU 505 may not necessarily follow the predicted trajectory, and thus the triggering conditions associated with the multi-hop CHO may not get fulfilled at each level in sequence. For example, WTRU 505 may have been configured with a CHO configuration from cell A 510 to cell B 520 to cell C 530, such as expected to follow trajectory 1 515, but its trajectory may change from the predicted trajectory 1 515 and a handover directly from cell A 510 to cell C 530 may be performed to accommodate the actual trajectory.

In one solution, a WTRU that has a multi-hop CHO configured monitors the triggering conditions of the target cells for more than one hop/level (e.g., all the target cells at all levels, the depth of the levels to be monitored indicated in the CHO configurations, etc.). For example, for the baseline multi-hop configuration shown above in FIG. 5A, if a depth of 2 is included in the configurations, WTRU 505 may monitor cell A 510, cell B 520, cell D 540, cell F 560, and cell G 570 at the same time, while at the source cell. Similarly, if a depth level of 3 is included (or the indication is to monitor all levels), the WTRU may monitor cell C 530 and cell E 550 as well. It can be configured such that not specifying the depth is equivalent to a depth level of 1.

If the triggering conditions towards a cell that is at a deeper level than the current level are fulfilled, the WTRU may not be able to execute the HO command associated with that target immediately. For example, assume for the baseline configuration above of FIG. 5A, and WTRU 505 is monitoring the third level (i.e., all target cell A 510, cell B 520, cell C 530, cell D 540, cell E 550, cell F 560 and cell G 570 are being monitored). If the conditions of cell C 530 are met, and WTRU 505 may attempt to directly execute the HO command associated with cell C 530. Doing so may cause a failure due to security reasons. This is because, the HO command_C was supposed to be executed after the WTRU has handed over to cell A 510 and then cell B 520. Since at least the security keys need to be updated at each HO command, WTRU 505 may not be able to compile the HO command_C while having only the security information of the source cell.

When WTRU 505 that has a multi-hop CHO configured and also configured to monitor more than one hop determines that the triggering conditions are fulfilled at a level deeper than the first level, the CHO configurations may be executed in sequence until that level is reached. For the example above, if the conditions to cell C 530 are met, WTRU 505 may execute HO command_A and HO command_B before executing HO command_C.

WTRU 505 may refrain from performing random access and may send a HO complete message only to the final target (i.e., skips the RA and sending of the complete message to the intermediate targets).

WTRU 505 may perform random access to the intermediate targets (e.g., cell A 510 and cell B 520 in the above example illustrated in FIG. 5A) and sends a HO complete message, but includes an indication that this is just a transitory HO. For example, when target A receives such an indication, target A can release the resources that it has reserved for that WTRU and informs the source cell to release the resources for that WTRU. This may ensure target A does not send any reconfiguration to the WTRU in the meantime that could change the WTRU context and disrupt the multi-hop handover procedure.

The WTRU may execute the security related configurations from the HO commands of the intermediate targets (e.g., A and B in the above example), before executing the HO command to the final target.

For a WTRU using multi-hop CHO configurations with timing constraints, as discussed above, configuring CHOs towards several targets is very resource intensive at the network, such as by using a legacy CHO configuration or in a multi-hop CHO presented herein.

The WTRU may be configured with a CHO configuration (e.g., a multi-hop CHO configuration) and the CHO configuration may include an associated validity time. This validity time indicates the time period or duration for the validity of the configuration. The validity time may identify the time period or duration that the network earmarks the resources to be available at the corresponding target cell to admit the WTRU. That is, when the specified time duration has elapsed after the reception of the configuration, the WTRU may delete/release that part of the configuration.

An example of how the validity time may be introduced to the baseline multi-hop CHO of FIG. 5A is provided:
1. CHO Config A:
   Target cell: cell A 510
   Triggering conditions (e.g., Cond A3 event with threshold_A)
   Validity time: t_A
   HO command_A
      2. CHO config B
         Target cell: cell B 520
         Triggering conditions (e.g., cond A3 event with threshold_B)
         Validity time: t_B
         HO command_B
         3. CHO config C
         Target cell: cell C 530
         Triggering conditions (e.g., cond A3 event with threshold_C)
         Validity Time: t_C
         HO command_C
      2. CHO config D
         Target cell: cell D 540
         Triggering conditions (e.g., cond A3 event with threshold_D)
         Validity time: t_D
         HO command_D
         3. CHO config E
         Target cell: cell E 550
         Triggering conditions (e.g., cond A3 event with threshold_E_1)
         Validity time: t_E
         HO command_E
1. CHO Config F:
   Target cell: cell F 560
   Triggering conditions (e.g., Cond A3 event with threshold_F)
   Validity time: t_F
   HO command_F
      2. CHO config G
         Target cell: cell G 570
         Triggering conditions (e.g., cond A3 event with threshold_G)
         Validity time: t_G
         HO command_G

If the WTRU monitors the first level targets, and assuming the above configuration was received all at once, the WTRU may start timers with values t_A and t_F during which the conditions of cell A and cell F are monitored, respectively. For example, if t_F was shorter than t_A and the timer associated with t_A expires before triggering conditions for cell A or cell F were fulfilled, the WTRU may delete the CHO configuration for cell F and the second hop configuration for cell G that is associated with cell F, and continues monitoring the triggering conditions for cell A.

Similarly, if t_A was shorter t_F and the timer associated with t_A expires before the triggering conditions for cell A or cell F were fulfilled, the WTRU may delete the CHO configuration for cell A, the second level CHO configuration for cell B and cell D, and the third level configuration for cell C and cell E, but keeps monitoring the triggering conditions for cell F.

The validity times for the second, and deeper levels can be interpreted in several ways, in the following examples. The validity times for a given level may be considered after the previous level conditions are fulfilled. For example, in the configuration above, the WTRU may start the timer associated with t_B after a CHO is executed towards cell A and cell B has become a first level target. The validity times for all levels may be considered from the reception of the configuration. For example, for the above configuration, assuming the configuration was received all at once, the WTRU may start the timers associated with all targets. Upon the expiry of each timer, the WTRU may delete the concerned configuration and any configurations dependent on that.

In one solution, the interpretation of the validity times in one of the ways described above is included as part of the CHO configuration or indicated to the WTRU in another dedicated signaling, or indicated to all WTRUs via a SIB signaling. In one solution, the interpretation of the validity times in one of the ways described above is explicitly specified in 3GPP standards.

In one solution, the WTRU may stop monitoring the conditions for a target when the validity timer associated with that target has expired. The WTRU may keep the configuration and the configurations in the deeper levels associated with that target, and start monitoring the conditions for the next level. For example, when the validity timer for target A expires, the WTRU may stop monitoring the conditions for cell A and start monitoring the triggering conditions for cell B, and start a timer with validity time t_B. If that also expires, the WTRU may stop monitoring the conditions for cell B and start monitoring the conditions for cell c, and start a timer with validity time t_C. If the conditions for cell C get fulfilled, then the WTRU may execute the HO command_A followed by HO command_B followed by HO command_C (or the other variants discussed in the previous sub section on executing a CHO command at a hop different from the current hop). Such a step-wise monitoring of the targets (i.e., monitoring only at one level, and considering the next level only when the validity time for the top level has expired) may ensure that the WTRU remains compliant with the limitation for a maximum number 8 CHO candidates that the WTRU can monitor simultaneously. One possible way to introduce the validity time in the multi-hop CHO configuration in the conditional reconfiguration IE is shown below:

| | |
|---|---|
| CondReconfigToAddMod-r18 ::= | SEQUENCE { |
| condReconfigId-r16 | CondReconfigId-r16, |
| condExecutionCond-r16 | SEQUENCE (SIZE (1..2)) OF |
| | MeasId |

OPTIONAL, -- Cond condReconfigAdd

| | |
|---|---|
| condRRCReconfig-r16 | OCTET STRING (CONTAINING |
| | RRCReconfiguration) |

OPTIONAL, -- Cond condReconfigAdd
...,

| | | |
|---|---|---|
| parentCondReconfigId-r18 | CondReconfigId-r16 | OPTIONAL, |
| condValidityTime | CondValidityTime | OPTIONAL |

}

The WTRU may use time based multi-hop CHO configurations with timing constraints. In one solution, the multi-hop CHO configuration may include timing information that includes start and end times for a given CHO configuration. An example with reference to FIG. 5A is provided below:
1. CHO Config A:
   Target cell: cell A 510
   Triggering conditions (e.g., Cond A3 event with threshold_A)
   Validity time: [t_A1, t_A2]
   HO command_A
      2. CHO config B
         Target cell: cell B 520
         Triggering conditions (e.g., cond A3 event with threshold_B)
         Validity time: [t_B1, t_B2]
         HO command_B
         3. CHO config C
         Target cell: cell C 530
         Triggering conditions (e.g., cond A3 event with threshold_C)
         Validity Time: [t_C1, t_C2]
         HO command_C
      2. CHO config D
         Target cell: cell D 540
         Triggering conditions (e.g., cond A3 event with threshold_D)
         Validity time: [t_D1, t_D2]
         HO command_D
         3. CHO config E
         Target cell: cell E 550
         Triggering conditions (e.g., cond A3 event with threshold_E_1)
         Validity time: [t_E1, t_E2]
         HO command_E
1. CHO Config F:
   Target cell: cell F 560
   Triggering conditions (e.g., Cond A3 event with threshold_F)
   Validity time: [t_F1, t_F2]
   HO command_F
      2. CHO config G
         Target cell: cell G 570
         Triggering conditions (e.g., cond A3 event with threshold_G)
         Validity time: [t_G1, t_G2]
         HO command_G

For the WTRU monitoring the first level targets as described, the t_A1 is 1 sec and t_A2 may be 3 seconds. Assuming the above configuration was received all at once, the WTRU may start monitoring conditions for target A after 1 sec has elapsed from the reception of the configuration and if the conditions for target A are not fulfilled after 3 second has elapsed from the reception of the configuration, the WTRU may delete the CHO configuration for cell A 510 and the second level CHO configuration for cell B 520 and cell D 540, and the third level configuration for cell C 530 and cell E 550.

In another example, t_A2 may be configured relative to t_A1 such that the duration for the monitoring for that particular configuration's trigger, instead of absolute time from the reception of the configuration. That is, for the example above with t_A1 set to 1 second and t_A2 set to 3 seconds, this may be equivalent to starting the monitoring for the conditions of cell A 510 after 1 second from the reception of the configuration and continuing to do so for 3 more seconds.

The start time may be included in a given CHO configuration, indicating that the WTRU may start monitoring the conditions for that specific CHO configuration from that time onwards, and may keep monitoring until the conditions are fulfilled or network sends explicit signaling to release the configuration. The inclusion of the end time may be equivalent to the validity time-based solution described herein above.

In the solutions described above, the time related information (validity time, start time, end time) may be relative times (e.g., seconds, milliseconds, etc.) from the reception of the configuration. Solutions are also contemplated where the time related information may be absolute time values. For example, a validity time may specify the exact time of the day (e.g., HH:MM:SS:ms) when the configuration becomes invalid. Similarly, the start and end time may be specified using the exact time of day. A mix of these two timing mechanisms—relative times and absolute times—may be used (e.g., “start time” specified in absolute time of the day format, “end time” specified as a time interval duration, e.g. in ms).

The WTRU may use a looping configuration cell A 510 to cell B 520, cell B 520 to cell A 510, etc. The WTRU may be configured with a multi-hop CHO configuration, where the second level is actually a CHO configuration back to the source cell, where the second level CHO may have two different thresholds. An example referring again to FIG. 5A is set forth below (a CHO configuration that was received while in cell A 510).
1. CHO Config A:
   Target cell: cell A 510
   Triggering conditions (e.g., Cond A3 event with threshold_A)
   Validity time: [t_A1, t_A2]
   HO command_A
      2. CHO config B
         Target cell: cell B 520
         Triggering conditions (e.g., cond A3 event with threshold_B)
         Validity time: [t_B1, t_B2]
         HO command_B
         3. CHO config A
         Target cell: cell A 510
         Triggering conditions1 (e.g., cond A3 event with threshold_A1)
         Triggering conditions1 (e.g., cond A3 event with threshold_A2)
         HO command_A

If the first CHO succeeds, then the WTRU may HO to cell B 520 and start monitoring the first triggering conditions for the HO from cell B 520 back to cell A 510 (i.e., threshold_A1). If that HO succeeds, HO may be handled using the processes described above where the second level CHO is to another cell and not to the source cell. If a failure occurs during the first CHO execution towards cell B 520 (e.g., unable to perform RA to cell B 520), the WTRU may check the if at least the second triggering conditions for the HO back to cell A 510 are fulfilled (i.e., threshold_A2). If the second triggering conditions for the HO back to cell A 510 is fulfilled, the WTRU may execute the CHO back towards the source cell A 510. In the described solutions of a multi-hop CHO configuration back to the source, when the source cell receives an RRC message from the WTRU after the configuration of the CHO, a confusion may arise whether the message was sent before the WTRU has executed the first level CHO (e.g., before the conditions for the first CHO were fulfilled) or after the WTRU has executed the second level CHO (e.g., the first CHO has failed and the second thresholds for the failure case were fulfilled and WTRU wants to go back to cell A 510).

FIG. 5B illustrates a method 545 associated with the exemplary coverage scenario of FIG. 5A. In line with the description above with respect to FIGS. 3A and 3B, a WTRU 505 moves in RRC_CONNECTED state in cell A 510 at 555. At 565, WTRU 510 is configured with a list of target cells. This configuration may include receiving a CHO configuration from NG-RAN node. This list of target cell may include target cells (B, C, D, E, F, G) and may provide cell evaluation criteria, that in one embodiment may be per cell. WTRU 505 may monitor cell evaluation criteria of at least one cell in the list of target cell, may monitor all cells in the list of target cells, or a subset of the cell in the list of target cells, at 575. At 585, when the criteria for at least one cell in the list of target cells is met, WTRU 510 may trigger HO to the at least one cell. For example, as WTRU 510 moves cell B 520, cell C 530 and cell D 540 may be monitored. As this movement leads WTRU to measure that the criteria of one cell (cell B 520, cell C 530 and cell D 540) is met, the HO to that cell may be triggered. For example, cell B 520 may be triggered.

Once the HO is triggered (such as to cell B 520), WTRU 510 may monitor the cell evaluation criteria for at least one other cell in the list of target cells at 595. This list may now include the remaining cells in the list (cell C 530 and cell D 540 in the example), may add in additional cells beyond those in the list, and may also include the cell that the WTRU moved from (cell A 510, for example), as is described in the details above. At 597, when the criteria for at least one other cell in the list of target cells is met, WTRU 510 may trigger HO to the at least one other cell. For example, as WTRU 510 moves in cell B 520, cell C 530 and cell D 540 may be monitored. A HO to another cell, such as cell C 530, may then cause method 545 to continue to iterate at 595 and 597 across the remaining cells in the list. Again as set forth above, this list may now include the remaining cells in the list (cell D 540 in the example), may add in additional cells beyond those in the list, and may also include the cells that the WTRU moved from (cell A 510 cell B 520as, for example), is described in the details above

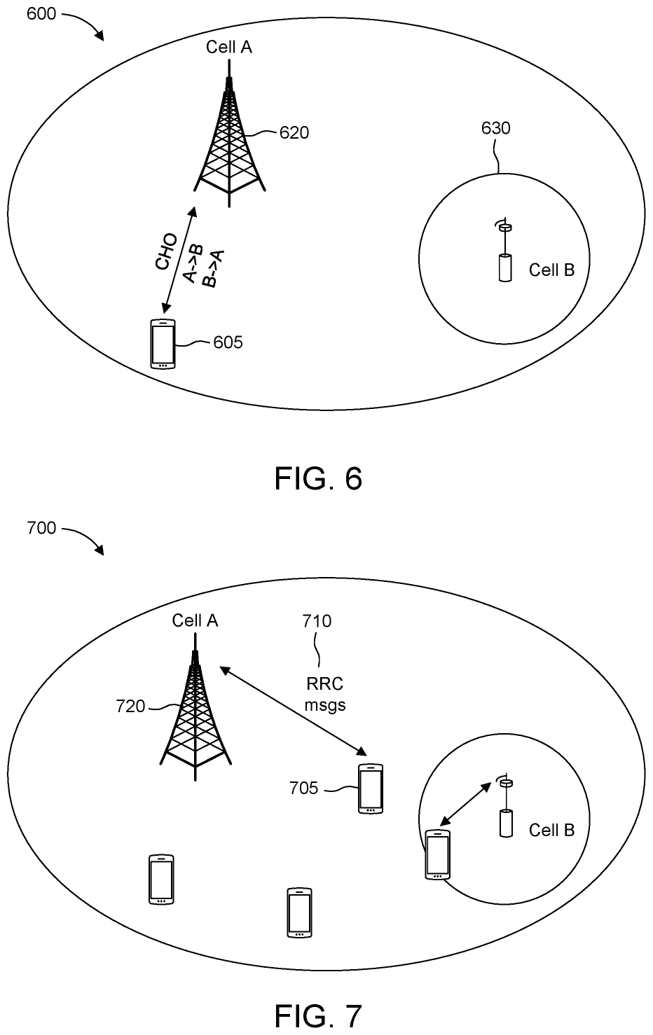

FIG. 6 illustrates a configuration 600 to illustrate the scenario of whether the message was sent before a WTRU 605 has executed the first level CHO 610. An assumption exists that if the first CHO 610 has succeeded, then the source cell A 620 may be notified by the target cell B 630, and thus confusing situation is mitigated. An initial step occurs where WTRU 605 receives a multi-hop CHO configuration, such as first from cell A 620 to cell B 630 and second from cell B 630 to cell A 620, for example.

FIG. 7 illustrates a configuration 700 to illustrate the scenario that while a WTRU 705 is monitoring for CHO trigger, i.e., monitoring the criteria for cell B, WTRU 705 may exchange one or more RRC messages 710 (e.g., measurement reports, UL information transfer, etc.) to cell A 720 using a first security context associated with cell A 720. This may occur when the CHO criteria is not met yet.

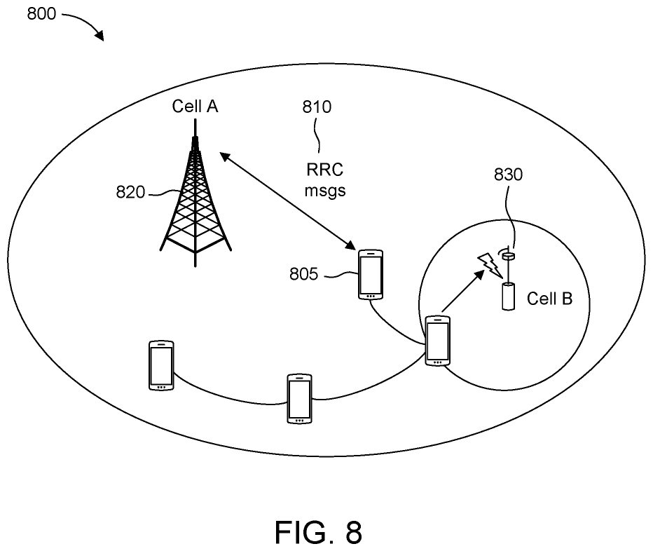

FIG. 8 illustrates a configuration 800 to illustrate the scenario when the trigger for cell A to cell B CHO is met, a WTRU 805 attempts CHO from cell A 820 to cell B 830. This attempted CHO fails (e.g., due to RACH failure in cell B 830). Note that by this time, WTRU 805 has applied the first HO command, and as such the security context is updated. WTRU 805 then applies a second CHO config from cell B 830 to cell A 820 (if the second trigger conditions are fulfilled as discussed above), which further updates the security context. Under this condition, WTRU 805 sends one or more RRC mgs 810 (e.g., RRC reconfig complete etc.) to cell A 820 using the latest security context to integrity protect and encrypt the message.

In scenario 700 of FIG. 7, the source node (cell A 720) may not experience an issue as the received RRC message was integrity protected and encrypted using the current security configuration at cell A 720. In the scenario 800 of FIG. 8, the security context for WTRU 805 at the network compared to the one that is being used at WTRU 805 are different. The integrity verification of the RRC message 810 sent from WTRU 805 (e.g., HO complete message) at the network may fail, and the message either discarded by the network or network may trigger some failure handling procedure. WTRU 805 may not be able to properly decode any UP messages from cell A 820, and if a CP message was sent from cell A 820 (e.g., an RRC message 810), the integrity verification of that message may fail, which is considered as an RLF, and may trigger re-establishment.

In one solution, the WTRU may be configured to transmit an indication (e.g., in a MAC CE) to the source cell that it has executed the second CHO after the first one has failed (e.g., before sending the Reconfiguration complete message after the second CHO is executed or multiplexed with the same message at the MAC level). That way, the network knows that it has to use the second security context for the WTRU going forward.

In one solution, the WTRU may be configured to store the first security configuration used in cell A, even after the conditions for CHO to cell B has been fulfilled, and if the HO to cell B does not succeed, reverts the security context back to the old security context, and does not execute the second CHO at all. The WTRU may send an indication/report to the network (e.g., RRC message, such as WTRU Assistance Information) that indicates that a failure has occurred during the first CHO.

The network aspects of the handover may be considered. In one solution, the handover procedure on the network side is enhanced to facilitate a multi-hop CHO, where a source node sends a handover request message to a target node that may indicate further targets for multi-hop CHO. For example, if the network wants to configure a CHO from cell A to cell B to cell C and cell A to cell B to cell D, the network may perform the following (assuming cells belong to different gNBs, for the sake of simplicity).

Cell A sends a HO request to cell B, indicating a multi-hop CHO with further targets cell C and cell D. Cell B performs admission control of the concerned WTRU.

If the admission control succeeds, cell B prepares the HO command for the first hop. Cell B may send a HO request to cell C and cell D, indicating a CHO (cell B may forward the WTRU context to cell C and cell D, after applying and delta configuration that may have been included in the HO command for the first hop). Cell C and cell D may perform the admission control and respond to cell B with either a HO preparation failure message (if they are unable to admit the WTRU) or a HO request ACK that includes the HO command for the second hop. Cell B sends a response to cell A. For example, if the admission at B has failed, a HO Preparation failure message is sent as the response.

If the admission at cell B has succeeded, but the second level has failed for both cell C and cell D, a HO request ACK message that includes the first hop HO command regarding cell B and an indication that the second level HOs did not succeed is sent as the response. The WTRU may receive a legacy CHO configuration regarding cell B.

If the admission at cell B, cell C and cell D has all succeeded, a HO request ACK message may be sent as the response. The message may include the first level HO command regarding cell B and the second level HO commands for both cell C and cell D. The WTRU may receive 2 multi-hop CHO configurations (cell A to cell B to cell C, cell A to cell B to cell D).

If the admission at cell B, and cell C has succeeded, but not to cell D, a HO request ACK message may be sent as the response. The message may include the first level HO command regarding cell B and the second level HO command for cell C and an indication that the second level HO to cell D has not succeeded. The WTRU may receive 1 multi-hop CHO configuration (cell A to cell B to cell C).

If the admission at cell B, and cell D has succeeded, but not to cell C, a HO request ACK message may be sent as the response. The message may include the first level HO command regarding cell B and the second level HO command for cell D and an indication that the second level HO to cell C has not succeeded. The WTRU may receive 1 multi-hop CHO configuration (A to B to D).

In one solution, the network configures the WTRU with multi-hop CHO configurations that have an associated validity time. The network may use information such as predicted WTRU trajectory and predicted resource needs at the network to determine the validity times for each handover target. The target node is also aware of the validity time and if a target node does not receive a HO complete message within the validity time associated with the CHO configuration for that node/cell, it may release the releases.

In one solution, the source node, after it has configured a WTRU with a multiple CHO configuration where the second level CHO is HO back to the source, performs a double decoding of RRC messages received from that WTRU on a need basis. That is, the source node may first use the first security context (e.g., that was used in the source cell when the CHO configuration was sent to the WTRU) for integrity verification and decryption of the received RRC message. If the integrity verification fails, then the source node may attempt with the second security context and may declare RLF and initiate re-establishment if this fails.

In one solution, the WTRU refrains from performing random access and sends a HO complete message only to the final target (i.e., skips the RA and sending of the complete message to the intermediate targets).

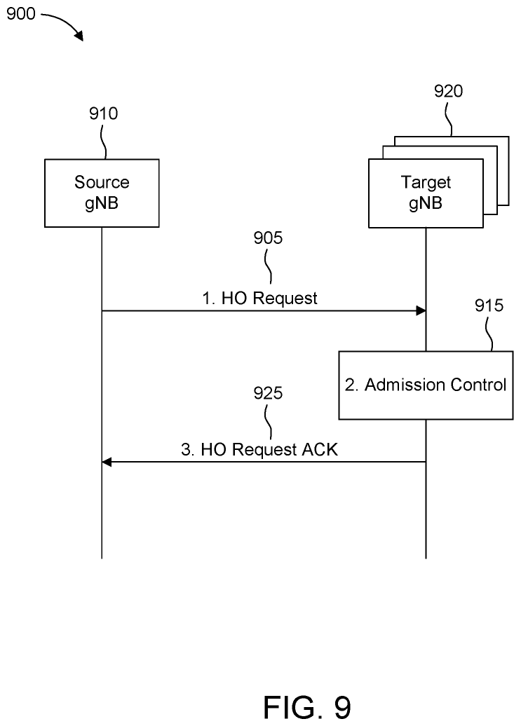

Exemplary procedures for WTRU configuration are provided. For the network resource reservation discussed hereinabove, FIG. 9 illustrates an enhanced HO request procedure 900. The source gNB 910 sends, at 905, a HO request to the target gNB 920 as described herein. The target gNB 920 performs admission control at 915 by evaluating if the WTRU can be accommodated in the future as compared to the legacy immediate evaluation. The target gNB 920 sends a HO Request ACK at 925 to the source gNB 910.

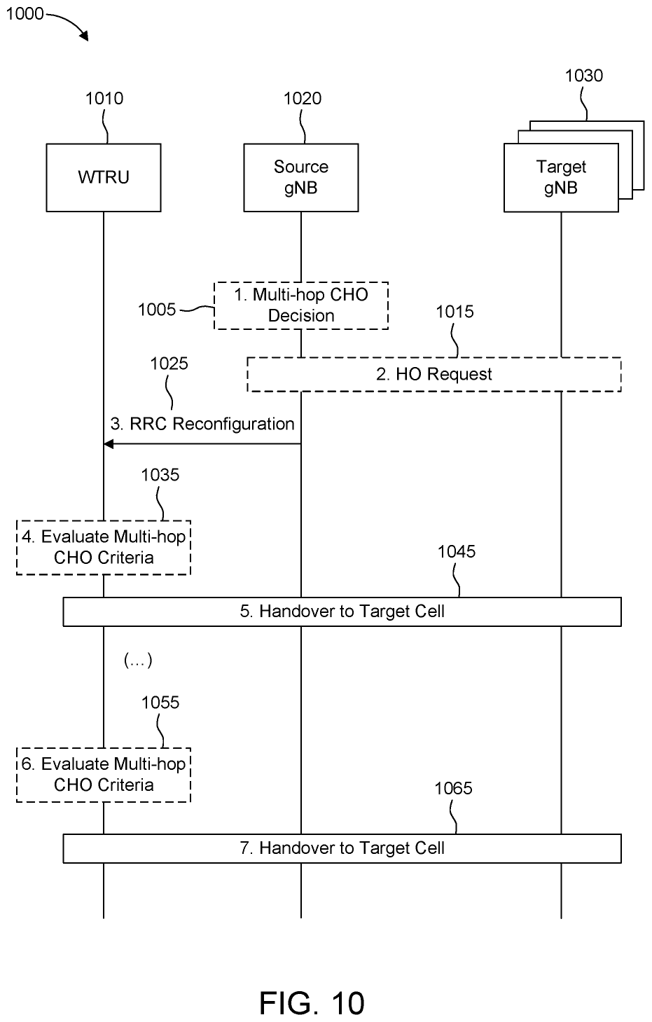

FIG. 10 illustrates a multi-hop CHO WTRU configuration and HO trigger procedure 1000. The source gNB 1020 concludes a multi-hop CHO configuration is the best mobility strategy for a WTRU 1010 at 1005. The source gNB 1020 performs, at 1015, enhanced HO request procedure as described herein. The source gNB 1020 provides, at 1025, WTRU 1010 with a multi-hop configuration as described herein. WTRU 1010 evaluates, at 1035, the radio conditions for a certain cell/level. WTRU 1010 triggers, at 1045, a CHO type HO to a target cell. WTRU 1010 evaluates, at 1055, the radio conditions for a certain cell/level for the second hop as described herein. WTRU 1010 triggers, at 1065, a CHO type HO to a target cell for the second hop. The triggering of a CHO type HO to a target cell may include WTRU 1010 establishing connection with the target cell. This may include the necessary sending and receiving of messages and, as necessary, registering within the cell, as would be understood to those possessing an ordinary skill in the art.

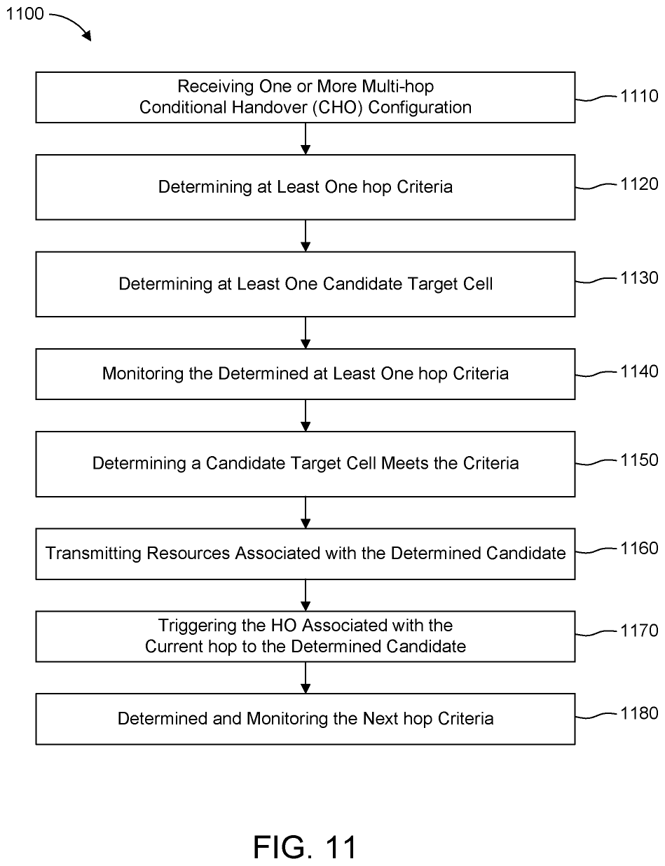

FIG. 11 illustrates a method 1100 that may be implemented by a WTRU. Method 1100 includes receiving one or more multi-hop conditional handover (CHO) configurations associated with multiple hops of a handover (HO) including at least one parameter of the one or more CHO configuration at 1110. The at least one parameter of the one or more CHO configuration may include one or more of a set of target cells associated with a source cell, per each hop, one or more measurement criteria for HO associated with each of the hops, and a validity time duration for the monitoring of the one or more criteria for each or a subset of source and target cells.

Method 1100 includes determining at least one hop criteria from the received one or more multi-hop CHO configurations at 1120. The determining at least one hop criteria at 1120 may be based on at least one of a multi-hop CHO configuration, a current hop, and a previous hop source cell-target cell pair.

Method 1100 includes determining at least one candidate target cell from the received one or more multi-hop CHO configurations at 1130. The determining at least one target cell at 1130 may be based on at least one of: a multi-hop CHO configuration, a previous hop source-target pair, a current cell, a previous cell.

Method 1100 includes monitoring the determined at least one hop criteria for at least one candidate target cell at 1140. Method 1100 includes determining a candidate target cell meets the criteria for the one or more monitored hop criteria at 1150. The target cell meeting the criteria at 1150 may include meeting a threshold on a measurement. The criteria is based on the multi-hop CHO configuration, the current hop and a previous hop.

Method 1100 includes transmitting using resources associated with the determined candidate target cell meeting the criteria at 1160.

Method 1100 may further include triggering the HO associated with the current hop to the determined candidate target cell meeting the criteria at 1170.

Method 1100, based on the target cell to which the WTRU performs HO, may further include determining and monitoring the next hop criteria, for one or more target cells, as per the multi-hop CHO configuration associated with the previous hops and HOs at 1180.

By way of example, the method may include receiving a plurality of multi-hop conditional handover (CHO) configurations, each configuration being associated with a hop criterion for a handover (HO), determining a first candidate target cell from the received plurality of multi-hop CHO configurations, monitoring a first hop criterion for the first candidate target cell, the first hop criterion associated with at least a first of the plurality of multi-hop CHO configurations, determining the first candidate target cell meets the first hop criterion using measurements associated with the first candidate target cell, establishing a connection to the determined first candidate target cell, determining a second candidate target cell from the received plurality of multi-hop CHO configurations, monitoring a second hop criterion for the second candidate target cell, the second hop criterion associated with at least a second of the plurality of multi-hop CHO configurations, determining the second candidate target cell meets the second hop criterion using measurements associated with the second candidate target cell, and establishing a connection to the determined second candidate target cell. The method may include releasing the connection to the determined first candidate target cell.

In the example, the method may include the monitoring a first hop criterion comprises the WTRU performing measurements and comparing the taken measurements to the first hop criterion. The method may include the first hop criterion and the second hop criterion being the same. The method may include transmitting using radio resources associated with the determined first candidate target cell based on the established connection with the determined first candidate target cell. The method may include transmitting using radio resources associated with the determined second candidate target cell based on the established connection with the determined second candidate target cell. The method may include monitoring a third hop criterion for a third candidate target cell, the third hop criterion associated with at least one of the plurality of multi-hop CHO configurations, determine the third candidate target cell meets the third hop criterion using measurements associated with the third candidate target cell and establishing a connection to the determined third candidate target cell. The method may include the received plurality of multi-hop CHO configurations comprising one or more of the following: a set of target cells associated with a source cell, per each hop; one or more measurement criteria for HO associated with each of the hops; and a validity time duration for the monitoring of the one or more criteria for each or a subset of source and target cells. The method may include the second hop criterion being based on at least one of: the received plurality of multi-hop CHO configurations; the established connection to the determined first candidate target cell; and a previous established connection of the WTRU and a previous hop criterion for a HO. The method may include determining the first target cell is based on at least one of: the received plurality of multi-hop CHO configurations, the established connection to the determined first candidate target cell, and a previous established connection of the WTRU and a previous hop criterion for a HO. The method may include the first candidate target cell meeting the first hop criterion includes exceeding a threshold on measurements associated with the first target cell.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method implemented by a wireless transmit receive unit (WTRU), the method comprising:
receiving a plurality of multi-hop conditional handover (CHO) configurations, each configuration being associated with a hop criterion for a handover (HO);
determining a first candidate target cell from the received plurality of multi-hop CHO configurations;
monitoring a first hop criterion for the first candidate target cell, the first hop criterion associated with at least a first of the plurality of multi-hop CHO configurations;
determining the first candidate target cell meets the first hop criterion using measurements associated with the first candidate target cell;
establishing a connection to the determined first candidate target cell;
determining a second candidate target cell from the received plurality of multi-hop CHO configurations;
monitoring a second hop criterion for the second candidate target cell, the second hop criterion associated with at least the first and a second of the plurality of multi-hop CHO configurations;
determining the second candidate target cell meets the second hop criterion using measurements associated with the second candidate target cell; and
establishing a connection to the determined second candidate target cell.

2. The method of claim 1 wherein monitoring at least a first hop criterion comprises the WTRU performing measurements and comparing the measurements to the first hop criterion.

3. The method of claim 1 wherein the first hop criterion and the second hop criterion are the same.

4. The method of claim 1 further comprising transmitting using radio resources associated with the determined first candidate target cell based on the established connection with the determined first candidate target cell.

5. The method of claim 1 further comprising transmitting using radio resources associated with the determined second candidate target cell based on the established connection with the determined second candidate target cell.

6. The method of claim 1, further comprising:
monitoring a third hop criterion for a third candidate target cell, the third hop criterion associated with at least the first, the second and a third of the plurality of multi-hop CHO configurations;
determining the third candidate target cell meets the third hop criterion using measurements associated with the third candidate target cell; and
establishing a connection to the determined third candidate target cell.

7. The method of claim 1, wherein the received plurality of multi-hop CHO configurations comprises one or more of the following:
a set of target cells associated with a source cell, per each hop;
one or more measurement criteria for HO associated with each of the hops; and
a validity time duration for the monitoring of the one or more criteria for each or a subset of source and target cells.

8. The method of claim 1, wherein the second hop criterion is based on at least one of:
the received plurality of multi-hop CHO configurations;
the established connection to the determined first candidate target cell; and
a previous established connection of the WTRU with an associated previous hop criterion for a HO.

9. The method of claim 1, wherein determining the first candidate target cell from the received plurality of multi-hop CHO configurations is based on at least one of: the received plurality of multi-hop CHO configurations, a current connection, and a previous established connection of the WTRU with an associated previous hop criterion for a HO.

10. The method of claim 1, wherein the first candidate target cell meeting the first hop criterion includes measurements associated with the first candidate target cell exceeding a threshold.

11. A wireless transmit and receive unit (WTRU), the WTRU comprising:
a transceiver; and
a processor operably connected to the transceiver, the processor and transceiver operating to:
receive a plurality of multi-hop conditional handover (CHO) configurations, each configuration being associated with a hop criterion for a handover (HO);
determine a first candidate target cell from the received plurality of multi-hop CHO configurations;
monitor a first hop criterion for the first candidate target cell, the first hop criterion associated with at least a first of the plurality of multi-hop CHO configurations;
determine the first candidate target cell meets the first hop criterion using measurements associated with the first candidate target cell;
establish a connection to the determined first candidate target cell;
determine a second candidate target cell from the received plurality of multi-hop CHO configurations;
monitor a second hop criterion for the second candidate target cell, the second hop criterion associated with at least the first and a second of the plurality of multi-hop CHO configurations;
determine the second candidate target cell meets the second hop criterion using measurements associated with the second candidate target cell; and
establish a connection to the determined second candidate target cell.

12. The WTRU of claim 11 wherein the monitoring a first hop criterion comprises the WTRU performing measurements and comparing the measurements to the first hop criterion.

13. The WTRU of claim 11 wherein the first hop criterion and the second hop criterion are the same.

14. The WTRU of claim 11 wherein the processor and transceiver further operate to transmit using radio resources associated with the determined first candidate target cell based on the established connection with the determined first candidate target cell.

15. The WTRU of claim 11 wherein the processor and transceiver further operate to transmit using radio resources associated with the determined second candidate target cell based on the established connection with the determined second candidate target cell.

16. The WTRU of claim 11, wherein the processor and transceiver further operate to:
monitor a third hop criterion for a third candidate target cell, the third hop criterion associated with at least the first, the second and a third of the plurality of multi-hop CHO configurations;
determine the third candidate target cell meets the third hop criterion using measurements associated with the third candidate target cell; and
establish a connection to the determined third candidate target cell.

17. The WTRU of claim 11, wherein the received plurality of multi-hop CHO configurations comprises one or more of the following:
a set of target cells associated with a source cell, per each hop;
one or more measurement criteria for HO associated with each of the hops; and
a validity time duration for the monitoring of the one or more criteria for each or a subset of source and target cells.

18. The WTRU of claim 11, wherein the second hop criterion is based on at least one of:
the received plurality of multi-hop CHO configurations;
the established connection to the determined first candidate target cell; and
a previous established connection of the WTRU with a previous hop criterion for a HO.

19. The WTRU of claim 11, wherein determining the first candidate target cell from the received plurality of multi-hop CHO configurations is based on at least one of: the received plurality of multi-hop CHO configurations, a current connection, and a previous established connection of the WTRU with an associated previous hop criterion for a HO.

20. The WTRU of claim 11, wherein the first candidate target cell meeting the first hop criterion includes measurements associated with the first candidate target cell exceeding a threshold.
